(19) United States
(12) Patent Application Publication
(10) Pub. No.: US 2003/0049591 A1
(43) Pub. Date: Mar. 13, 2003

(54) Method and system for multimedia production and recording

(76) Inventor: Aaron Fechter, Orlando, FL (US)

Correspondence Address: BEUSSE, BROWNLEE, BOWDOIN & WOLTER, P. A., 390 NORTH ORANGE AVENUE, SUITE 2500, ORLANDO, FL, 32801, US

(21) Appl. No.: 10/241,337

(22) Filed: Sep. 11, 2002

Related U.S. Application Data
(60) Provisional application No. 60/322,165, filed on Sep. 12, 2001.

(51) Int. Cl. G09B 5/00

(52) U.S. Cl. 434/307 A

(57) ABSTRACT

A method and system for multimedia production and recording of performances is provided. More specifically, the invention provides a method and system for multimedia production of live performances incorporating sound and image processing, special effects, mixing, recording, and broadcasting. The invention can be implemented in numerous ways, including as a video production system, an entertainment device, and a method. Moreover, it produces recorded media and a variety show.

### CROSS-REFERENCE TO RELATED APPLICATIONS

This application claims priority from U.S. provisional application, serial No. 60/322,165 filed Sep. 12, 2001, the disclosure of which is incorporated herein by reference in its entirety.

### TECHNICAL FIELD

The present invention relates to multimedia production and recording. More specifically, the invention relates to a method and system for multimedia production of live performances incorporating sound and image processing, special effects, mixing, recording, and broadcasting.

### BACKGROUND ART

Multimedia entertainment takes on many forms. For example, nightclubs often offer karaoke to their customers as a form of entertainment. A conventional karaoke machine plays an instrumental accompaniment of a requested song, which is mixed with a live vocal performance of the customer, while the lyrics of the requested song are displayed on a monitor. A background video image apparatus is used to provide the singing environment. Karaoke networks are also available in which a plurality of karaoke stations, each of which is installed in a business establishment, are connected to a host computer, some of which even provide commercials during intermission periods. Some entertainment centers employ a karaoke DJ or host to select a karaoke song, to announce the singer to the audience, and mix the audio. After the performance, the DJ will encourage applause from the audience, select the next performer based on his notes. Sometimes, the DJ makes an audio cassette recording of the performance or a videographer makes a video tape.

A number of patents exist which relate to karaoke systems including U.S. Pat. Nos. 5,532,923; 5,609,486; 5,863,206; 5,947,746; 6,072,933; 6,074,215; 6,086,380; 6,206,704; and 6,328,570, all of which are incorporated herein by reference. One of these systems, U.S. Pat. No. 6,086,380 also provides for recording a video and audio performance of a customer and providing a video tape to the customer for a fee. The performance takes place in a sealed booth and there is no DJ encouraging applause nor is there any public display of the performance.

### BRIEF SUMMARY OF THE INVENTION

Broadly speaking, the present invention provides a method and system for multimedia production and recording of performances. More specifically, the invention provides a method and system for multimedia production of live performances incorporating sound and image processing, special effects, mixing, recording, and broadcasting.

The invention can be implemented in numerous ways, including as a video production system, an entertainment device, and a method. Moreover, it produces recorded media. Several embodiments of the invention are included. In one aspect of the invention, a method for providing multimedia entertainment, includes (a) providing a source of stored multimedia segments; (b) receiving user supplied real-time multimedia signals; (c) interleaving the stored multimedia segments with the real-time multimedia signals to produce a combined multimedia output; and (d) displaying the combined multimedia output (immediate or delayed). The multimedia includes images and sound. The method further includes transmitting the combined multimedia output to a remote location over a communications network including broadband, baseband, or radio broadcast transmission. It may also include storing the combined multimedia output and storing the user supplied real-time multimedia signals as user supplied segments. In a further aspect of the invention, the stored multimedia segments can be selected randomly from a plurality of pre-recorded segments or selected from a plurality of pre-recorded segments in accordance with predetermined criteria. The stored multimedia segments include at least one pre-recorded segment of an entertainment host interleaved at the beginning of the user supplied real-time multimedia signals (e.g., an introduction) and at least one pre-recorded segment of an entertainment host interleaved at the end of the user supplied real-time multimedia signal (a postscript). Advertisements and information may also be interleaved therewith.

In a specific aspect of the invention, the user supplied real-time multimedia signals are derived from a audio-visual karaoke system where the system uses a source of selectable musical compositions that include both music and lyrics; a first video display screen for displaying the lyrics to the user; an input device for receiving the user supplied real-time multimedia signals; wherein the multimedia signals comprise audio input from the user and video input from the user; an audio mixing device for mixing the audio input from the user with the music to provide a combined audio output; and a multimedia integration device for interleaving video input from the user, the combined audio output, and the stored multimedia segments. A second video display screen for displaying a video portion of the combined multimedia output may be included. The method also includes capturing at least a portion of the combined multimedia output as an archive and/or supplying the portion to the user.

As a multimedia entertainment system, in an aspect of the invention, the system includes a source of stored multimedia segments; apparatus for receiving user supplied real-time multimedia signals; an integration device for interleaving the stored multimedia segments with the real-time multimedia signals to produce a combined multimedia output; and an output device for outputting the combined multimedia output. The system operates to perform the methods of the invention and provides a combined multimedia output of interleaved segments including (a) stored multimedia segments comprising at least one of host multimedia segments, advertising multimedia segments, and information multimedia segments; (b) real-time multimedia signals comprising user audio input signals mixed with music and video input signals; and (C) stored portions of the realtime multimedia signals. The stored portions of the real-time multimedia signals are enhanced with special effects.

A multimedia storage medium (e.g., video tape. DVD, vCD) is produced by the method of the invention having the combined multimedia output stored thereon. The medium includes (a) stored multimedia segments comprising at least one of host multimedia segments, advertising multimedia segments, and information multimedia segments; (b) real-time multimedia signals comprising user audio input signals mixed with music and video input signals; and (c) stored portions of the real-time multimedia signals.

A real-time broadcast is also produced by the method which includes a broadcast of the combined multimedia output.

The advantages of the invention are numerous. One significant advantage of the invention is that it creates a live show during the performance with a host segment(s) (and commercials if desired) interleaved therewith without the use of a “live” host. Customers may view and purchase their individual performance with the interleaved segments. The invention also creates shows based on past performances that can be broadcast (television, cable, Internet, satellite, and the like). As a result, a talent scout may have the opportunity to view these performances, giving performers a chance to be discovered.

All in all, the invention provides an exciting and entertaining experience for the performer and the audience, creating not only a well-produced program for distribution, but also a recorded keepsake for the performer.

Other aspects and advantages of the invention will become apparent from the following detailed description taken in conjunction with the accompanying drawings, illustrating, by way of example, the principles of the invention.

All patents, patent applications, provisional applications, and publications referred to or cited herein, or from which a claim for benefit of priority has been made, are incorporated herein by reference in their entirety to the extent they are not inconsistent with the explicit teachings of this specification.

### BRIEF DESCRIPTION OF THE DRAWINGS

In order that the manner in which the above-recited and other advantages and objects of the invention are obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 is a perspective view of an entertainment device according to one aspect of the invention.

FIG. 2 is a generalized block diagram of a system according to one aspect of the present invention.

### DETAILED DESCRIPTION OF THE INVENTION

Referring now to the drawings, embodiments of the present invention will be described.

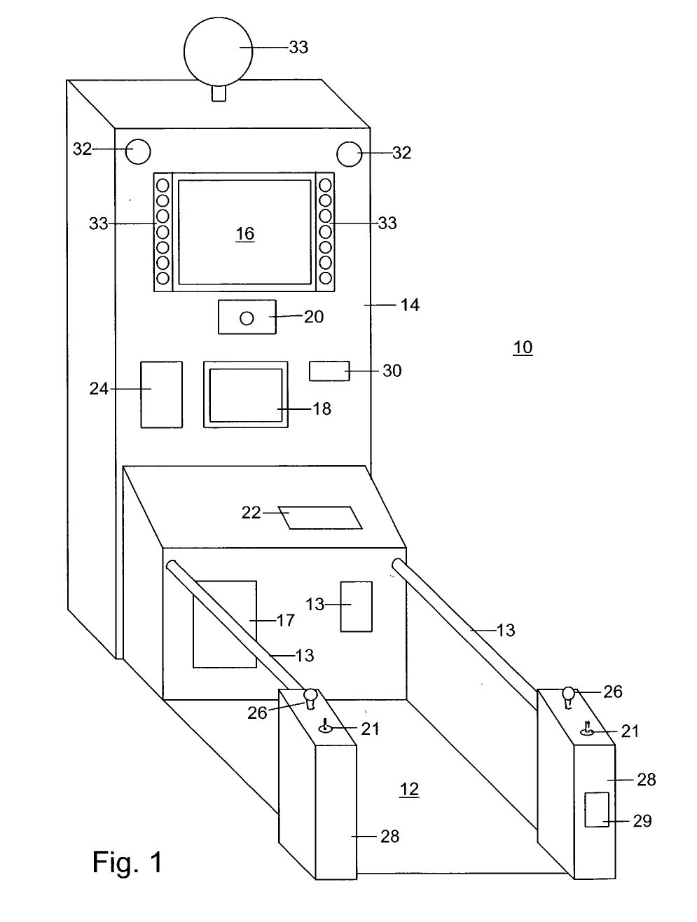

FIG. 1 is a perspective view of an entertainment device 10 according to one aspect of the invention in its deployed state. Preferably, the entertainment device 10 is in the form of an upright structure, arranged to be positioned on any horizontal surface, similar to a kiosk. The entertainment device 10 can be of other shapes and/or sizes than that shown in FIG. 1 and described hereinafter. Thus, it must be appreciated that the embodiment of the device 10 shown herein is merely one exemplary embodiment of the invention. The device 10 includes a stage area 12 extending substantially horizontally outwardly for the performer. The stage area 12 further includes side barriers 13, such as railings, to partially or fully enclose the stage area 12. In one embodiment, the stage area 12 can be folded upright for portability.

The entertainment device 10 is arranged to be deployed at any location for easy visibility by persons passing by, and is particularly suitable for entertainment centers having game rooms or the like. The device 10 can be of any shape, depending upon aesthetics or other reasons. Thus, the particular shape of the device shown herein, i.e., rectangular, is merely exemplary of a myriad of shapes the device can assume. It can also be constructed using a variety of conventional metal, plastic, or wood framing techniques. A variety of accent arrangements can be provided, depending upon the esthetics of the mounting location and/or user preference. The device 10 can be readily fitted to available wall space or central floor space at any user site. With the exception of necessary power and optional telephone connections, the device 10 requires no special electrical or plumbing connections. The device 10 occupies a floor space of approximately 4 feet×10 to 15 feet. In a typical setting, the entertainment device 10 might be located in a restaurant or lounge, food court, entertainment center, resort or hotel, amusement park, arcade, cruise ship, or provided to other locations as a temporary rental for birthday parties and reunions.

A viewing area 14 extends vertically in front of the stage area and comprises a first viewing monitor 16, such as a computer screen, television monitor, LCD display or the like, to display, for example, live and pre-recorded performances. Additional remote viewing monitors (not shown) may be connected to the entertainment device 10 to broadcast the live and recorded performances. Loudspeaker 17 is also provided for audio output. Remote audio output (not shown) may also be provided.

In an embodiment, the device 10 comprises a second viewing monitor 18 to provide a user interface with the device 10. The second viewing monitor 18 is a computer screen, television monitor, LCD display, touch screen, or the like. When operated as a karaoke entertainment center, the second viewing monitor 18 is programmed to display user instructions and the lyrics for the selected song. The function of the second viewing monitor 18 may be combined with the first viewing monitor 16 such that the user interface (e.g., instructions, lyrics) are superimposed over the first viewing monitor 16. The remote monitors (not shown) may be programmed not to display the user interface, only the live and recorded performances, since only the performer needs to view the user interface.

At least one visual recording device 20, such as a digital or analog video camera, is positioned on or about the viewing area 14 to visually capture the performance. The camera 20 is adapted for movement and may be controlled in a known fashion, including zoom, pan, etc. Camera control may be automatically performed by the device or external controls 21 may be provided. In one aspect, the camera zoom and pan as well as techniques for locking on to the performer are automatically controlled. The performer may input his height so the various control sequences operate within that setting.

The entertainment device further includes an input device 22 such as a series of control buttons/arrow keys, keyboard (wired or wireless), mouse, touch pad, touch screen, or other peripheral equipment that may be used by the performer to interact with and operate the device 10. Operational functions may include, for example, browsing and selecting songs. The input device 22 may be combined with either viewing monitor 16 or 18. A second input device (not shown) may be provided (or protected/password access using the first input device 22) for administrative access to control the entertainment device 10 and its administrative functions. The administrative functionality may include the ability to delete performances, add new songs, control settings, and the like. The user interface of the present invention allows the user to browse the database of songs, perform searches for songs, make selections, and the like. It may be implemented as a “windows” type system with control via an input device (e.g., pointing device, touch screen, arrow keys, mouse) or as a selectable list. If implemented using windows applications, each display screen of the invention can comprises a window title bar, a menu bar (with command such as File, Edit, and the like), a tool bar (with options such as Close, Paste, Clear, and the like), and an information display region. The information display region may, for example, display a query window or a results window.

The device 10 is also provided with a conventional payment receiving device 24 such as a currency scanner (bill acceptor), token or coin receiver, credit/debit card scanner, or the like.

An audio input device 26, such as a conventional audio microphone(s), is provided for voice input by the performer. The microphone 26 may be cordless, provided with a retractable cord of sufficient length to be used by the performer, or fixed in a stationary position. Additional microphones (not shown) may be provided for additional performers. In a specific embodiment of the invention, the device includes a control station 28 at the end of one or both side barriers 13 nearer to the performer. When not in use, the microphone(s) 26 retracts into the control station 28. An audio input jack (29) may also be provided for the device 10, located on the control station 28, for example, to receive audio input from an instrument (e.g., electric guitar). Additional input/output ports (not shown) for coupling external devices may be provided, such as headphone ports, video output ports, microphone input ports, audio output ports, and the like. As standard connectors, these ports couple to various external devices as is well known in the art.

A recorded media dispenser 30 is provided to dispense recorded media, such as an audio tape, video tape, compact disc (CD), digital video disc (DVD), or video compact disc (vCD), to allow the performer to obtain a copy of his/her performance on the recorded media. A supply of units of different types of recording media may be provided or a performer may provide his own.

A ticket dispenser 31 may be provided to reward participants who use the entertainment device. The dispenser 31 may be automatically programmed to dispense a predetermined amount of redemption tickets after a performance as a reward, especially for children. The children can then cash in the tickets for prizes or other rewards.

Spot lights 32 may be provided for adding lighting effects to the performance as well as additional effects lighting 33. Preferably, the spot lights 32 are automatically controlled and timed to turn on during the “record” phase of the performance. The effects lighting 33 includes, for example, colorful effects lights at the top of the device and “Hollywood” style lights strategically placed on the device, such as around the viewing monitor, to provide excitement to the performance and may be synchronized with audio effects such as with an applause audio track.

In order to provide access to the interior of the device for servicing of its interior components, a doorway (not shown) is located in behind the viewing area 14. A lock (not shown) is provided in the door to prevent unauthorized access into the interior of the device 10.

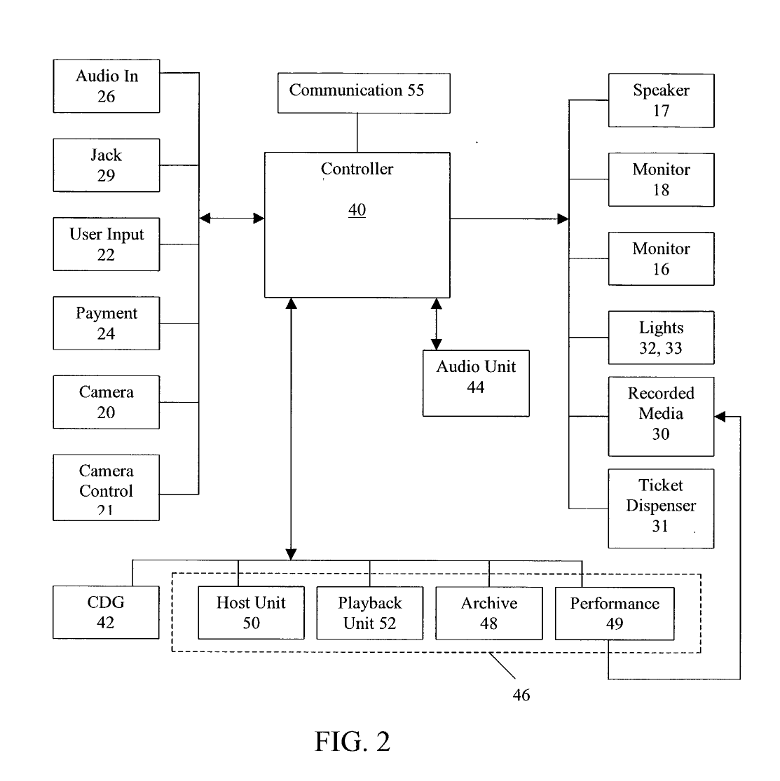

Turning now to FIG. 2, a generalized block diagram of a system according to one aspect of the present invention is shown. A controller 40 is used to perform the necessary control and switching in order to operate the device in accordance with the present invention. The controller may be general purpose or special purpose computer hardware, software, and firmware embodying the method of the invention, including, but not limited to, a central processing unit (CPU), memory, storage devices, communication links and devices, servers, I/O devices, switching devices, or any sub-components of one or more processing systems, including software, firmware, hardware or any combination or subset thereof, which embody the invention.

When operated as a karaoke entertainment device, karaoke storage unit 42 (such as a CD+G Changer) stores the song data, audio data, lyrics, and graphics. The unit 42 provides the graphical lyrics to the viewing monitor 18 through appropriate switching devices in the controller and audio output to the speaker 17 through appropriate switching, synthesizing, filtering, amplifying, mixing devices, as known in the art. Preferably, each of the stored songs has been previously marked with predetermined timing codes since timing of the switching of the audio and video is key to seamless integration. The karaoke storage unit 42 can be any device which will hold data. For example, it can consist of any type of magnetic or optical storing device (e.g., CDROM, internal hard drive, tape drive). It can be located remote to the device (with access via modem or leased line) or locally to the device 10.

In a specific embodiment, since each song in the karaoke storage unit 42 varies in length and may have a different amount of “dead air” before the start of the song, each song is measured and timing codes are associated at different points in the song. For example, timing codes include “dead air” time, song introduction time, song length, and a predetermined number of intermediate points. Intermediate points are used to select a predetermined segnent(s) of a song, hereinafter referred to as “highlights,” with “punch-in” and “punch-out” points defining the beginning and ending of the segment. The highlight may be the chorus or another predetermined point in the song selected to be the “highlight” of the performance. Selection of the highlights may be based on the chorus, another verse in the song, popular lines in the song, or other factors such as length, difficulty of lyrics, solo vocals, or the like. The highlights of the performances are used to create a “variety show” after the performer has finished wherein the exact edit points (punch-in and punch-out) determine where the highlight is for each individual song. Other timing codes include various equipment latency factors such as those found controlling the components.

A plurality of previously recorded video clips are also included, referred to herein as “host clips.” As used herein, host clips include any number of pre-recorded video segments, including “host segments” for introducing a performer or eliciting applause, commercial segments, informational segments, various karaoke selections, and the like. These clips are preferably interleaved with individual performances during the live performance and/or with the performance highlights in producing the “variety show.” Specifically, the host clips fill the time in between performances and “performance replays” so that a continuous live show can be displayed on the viewing monitor. Host clips are also interleaved with the performance highlights to produce the “variety show” by editing together a continuous show from the highlights and clips. Certain host clips are also included on the recorded media 30 provided to an individual performer. “Performance replays” are used to add effects and enhance the live show, variety show, and the individual recorded performance. For example, a performance reply may include a 20 second slow motion clip of the last performer with an overlayed music bed from a randomly selected karaoke song as a spacer between the last performance and the next. The slow motion replay adds a touching moment to the show and prepares the audience for a new segment.

The host segments may star any number of hosts, thereby making it possible to select a particular host or hosting “style.” Host clips can be recorded by the entertainment device itself. Similarly, a variety of commercial segments and informational segments are included and may be selected according to the segment itself or the “style” of segment. For example, if the entertainment device is being used at a children's entertainment center, the center may choose to select a children's host (Barney for kids), children's commercials (softdrinks, cereals, toys), and children's information (abbreviated and simple instructions for using the device). If, on the other hand, the entertainment device 10 is being used at a country bar, the bar may choose to select a host with a country theme (Bubba), more mature commercials (beer, automobiles), and more detailed information (additional instructions and options). Each of the clips may be rated using a system that provides for ease of selection of themes using multiple factors. For example, segments can be rated for violence, maturity, language, sexual content, alcohol, etc. so that an administrator may choose not to play any segments with a specific factor such as alcohol or a combination of factors (alcohol and sexual content).

Each host clip is stored and identified with an identification code for cataloging and searching. Host clips may be divided into categories depending on the purpose of the clip. For example, host segments may be categorized as “intros” meaning clips preceding a performance or “outros” meaning clips following a performance. Clips may include teaser intros and outros to get audience attention and motivate performer participation, performer intros and outros to introduce the next performer and elicit applause after the performance, commercials, commercial intros and outros, instructions for use, intermissions, announcements, etc. The host clips are designed such that someone viewing the show cannot tell whether the host is live or pre-recorded since the host appears to be interacting with the performer or audience. Timing codes for the host clips are measured for accurate switching and seamless integration into the shows. Controller 40 utilizes the host clip timing codes as well as the host clip categories, identification codes, order preference codes, and the like to interleave the host clips.

In one aspect of the invention, the entertainment device 10 operates in two modes: standby mode and run mode. In standby mode (when no one is using the entertainment device to perform a song, comedy routine, or other performance), the entertainment device 10 is programmed to provide continuous playback on the viewing monitor 18 for entertainment. In a preferred embodiment, the playback comprises a continuous “variety show” including interleaved host clips and recently (or previously) recorded performances or “highlights” of the performances. Teaser segments are used to encourage participation from the audience and promote the device. By utilizing synchronized DVRs and proper scripting, a seamless integration of these clips results in an entertaining and dynamic “variety show” for the audience, especially those performers who recently performed on the device 10.

In run mode, the viewing monitor switches from the “variety show” to a “live performance,” since a performer is interacting with the entertainment device 10. Initially, the performer activates the run mode by inserting the appropriate payment in the payment receiving device 24 (for fee-operated devices) or activating a start function such as a button on the input device 22. Optional motion detectors or other types of sensors may be used to activate the run mode. The performer selects a song and the “live” performance session begins with an intro host segment announcing the performer while the song is cued up. Once the song is cued and the host segment completed the song starts with the performer singing along.

During the performance, controller 40 receives the various inputs from the audio input device 26, audio jack 29, and camera control 21. Audio unit 44 mixes and synthesizes music from the karaoke storage unit 40 with voice input from the microphone 26 (along with any other audio input) to form a mixed sound output to the speaker 17. The audio unit 44 functions to control and equalize audio input to adjust for varying voice levels so that, for example, both a weak voiced performer and a strong voiced performer both end up with an appropriate voice level output. Controller 40 then controls/produces output including audio through speaker 17, lyrics on viewing monitor 18, live playback of performance on viewing monitor 16, and lights 32, 33. At the end of the song, an outro host segment is played. For example, the host announces that an instant playback “highlight” of the performance will follow. The highlight is then replayed on the viewing monitor 16, which is the same highlight saved for use on the “variety show.” After the highlight, another outro host segment is played to elicit applause and to solicit the performer to buy a keepsake video tape of the individual performance.

Recording unit 46 is provided for recording and playback in accordance with the aspects of the invention. In a specific embodiment a plurality of individual recording/playback units are provided to avoid delays if only a single unit was used to provide all recording/playback functions of the invention. Multiple units are preferred so that a plurality of media may be provided and so that both recording and playback can be carried out at the same time. However, use of a single unit is contemplated provided it can perform the aspects of the invention.

In a specific embodiment, two recording units are dedicated for archiving performances and providing removable recorded media of the performances (e.g., keepsake video tape). The first recording unit is referred to herein as an archive recording unit 48 (e.g., VCR, DVD-R, vCD-R, DVD-ROM recorders) for making an archive copy of all performances, which may be, for example, kept by the system administrator or business for archival or security purposes. The archive recording unit 48 provides recorded media of all unedited performances over a specific time period. The second recording unit is referred to herein as a performance recording unit 49 (e.g., VCR, DVD-R, vCD-R, DVD-ROM recorders) for making a copy of an individual performance. The performance recording unit 49 is designed to dispense recorded media (e.g., VCR tapes, DVDs, vCDs) to the performer through the recorded media dispenser 30. The recorded media may include various host clips associated with the particular performance, including intros and outros, commercials, and the like. Use of either or both recording units is optional. Alternately, individual performances are not recorded on recorded media but are provided to the performer via electronic communication means, as detailed hereafter.

Also included are two units for recording/playback of interleaved video clips and performance replays. The first unit contains prerecorded video clips (host clips, previous highlights, etc.), referred to herein as the host unit 50. The second unit records live performances for playback (performance replays), referred to herein as the playback unit 52. In a preferred embodiment, these units are digital video recorders (DVR) utilizing a hard drive rather than removable media for fast access and switching, such as TiVO brand DVRs. The DVRs provide record, rewind, instant replay, and slow-motion capabilities. Utilizing two units 50, 52 allows playback of one unit while preparing for playback of the other unit. Seamless switching between units results in the ability to interleave pre-recorded host clips with live performances and instant replays of live performances (performance replays). Alternatively, an appropriately programmed computer device (such as a PC) may also provide the necessary functionality to allow for seamless interleaving of clips to avoid the need for dual components.

The timing of the switching of the audio and video is performed by the controller 40. The controller activates the various independent recording units 48, 49, 50, and 52 with various content on each recorder according to whether a performance, commercial, instruction clip, or other type of video recording is next in the timing sequence. The embedded processors in the DVRs provide simple real-time control for recording and playback. Other systems having similar functionality, including Windows based systems may be used.

In a specific embodiment, host clips are assigned a number, type, description, title, length in seconds, length in hex, and order. The length of the clips does not include the preroll time. It is measured from the moment the video switch is to be made to the moment switch out from the clip is made. After these are loaded into the host unit 50, a “Do Not Erase” flag is set on each clip. Intros use ½ minutes of trailing video after the cut point and outros use 15-20 seconds after the cut point. Flyer is set to 5¾ seconds before audio cut in and started and REC is pressed at the same time, resulting in 5 seconds of preroll on the host unit. Where no preroll is used, set Flyer to 3 seconds before audio cut in point. The audio from Flyer to host unit 50 may be boosted. When clips are added to the host unit 50, such as a pair of clips to introduce teasers, they are added to the top of the Now Showing List and all other clips already in the host unit 50 which are defined in the charts will have their data pushed down the list by one byte per clip added. If a teaser intro and matching outro is added, existing clip definitions and length bytes will be pushed down the charts by two bytes. An order chart tells what order to play the teaser intros. A pointer will point to a byte in the chart which gives the actual clip number on the host unit 50 which, if decremented is the offset in the chart. The pointer is incremented to get the next teaser intro clip number. The pointer value is used as an offset to the order chart and the value is pulled out of the chart for the desired clip, the value decremented, and it is used as an offset to get the clip length.

Another list used in the system includes the CDG Background list to provide a list of CDG cuts that will be used as background music at the end of a teaser outro, bridging the silence between teasers while the slow motion end of the last teaser clip is playing and the host unit is finding its next intro. Additional time may be added as desired. Lyrics can be displayed between teasers.

In one aspect of the invention, the various components (camera 20, karaoke storage unit 42, recording units 48, 49, 50, 52, etc.) communicate through infrared transmitters/receivers (not shown). The infrared control signals for each component are captured and stored by the controller 40 for precise control of the various components. An advantage of this communication scheme is that in the event a component requires replacement, the infrared control signal for the replacement component is easily captured and stored by the controller, making interconnections much simpler than direct wiring. Optionally, component control may be by any other means as known in the art such as direct wiring, radio, I/O bus, etc.

In accordance with another aspect of the present invention, entertainment device 10 may be provided with communication circuitry 55 for enabling communications (transmitting and receiving) over a communication network (e.g., the Internet, the public switched telephone network, a local area network, airwaves, etc.) to remote web servers, remote receivers, and remote personal computers. Communication circuitry 55 may, for example, comprise a modem or network interface circuitry and is usable, for example, to transmit live shows, pre-recorded shows, variety shows, recorded segments, or the like, as streaming video or using file transfer protocol, over the communication network. The dynamically produced variety shows may then be played on websites or broadcast on television, cable, or the like. Moreover, in this way, individual performances may be electronically mailed as an email attachment or as an electronic greeting card. The e-mail address(es) of the recipient(s) may be entered using input device 22. Communications circuitry 55 may further comprise an antenna (not shown) allowing signals to be broadcast on specific frequencies for reception by a receiver. Design of an antenna is well known and any appropriate antenna design may be used. Since each entertainment device 10 produces its own variety show, multiple shows or multiple channels broadcasting the shows can be offered. The variety shows from different entertainment devices or from the same device but over a specified time period can be edited into new and different shows, including the “Best of the Best” or the “Worst of the Worst,” resulting in a new form of reality TV with minimal production costs. In a sense, the entertainment device 10 is a television show production device. Remotely located entertainment devices 10 can send and receive clips and performance highlights from other entertainment devices to change its local variety show.

The entertainment device is not limited to karaoke performances. It also includes comedy, acting, and other performing arts. Moreover, it can be implemented as a teaching device. As a teaching device, the teacher records the information he wants to teach as a “performance clip.” The device 10 integrates that clip, be it a lesson, poem, story, lecture, or the like, into a larger “educational show” that is automatically assembled and presented to students (the audience). As the students watch this educational show, their attention is drawn to the ever changing production, but occasionally they will see repeated clips to assist in the learning process. The students themselves may also participate by presenting a concept as a performance clip.

Based on the foregoing specification, the invention may be implemented using computer programming or engineering techniques including computer software, firmware, hardware or any combination or subset thereof. Any such resulting program, having computer-readable code means, may be embodied or provided within one or more computer-readable media, thereby making a computer program product, i.e., an article of manufacture, according to the invention. The computer readable media may be, for instance, a fixed (hard) drive, diskette, optical disk, magnetic tape, semiconductor memory such as read-only memory (ROM), etc., or any transmitting/receiving medium such as the Internet or other communication network or link. The article of manufacture containing the computer code may be made and/or used by executing the code directly from one medium, by copying the code from one medium to another medium, or by transmitting the code over a network.

One skilled in the art of computer science will easily be able to combine the software created as described with appropriate general purpose or special purpose computer hardware to create a computer system or computer sub-system embodying the method of the invention. An apparatus for making, using or selling the invention may be one or more processing systems including, but not limited to, a central processing unit (CPU), memory, storage devices, communication links and devices, servers, I/O devices, or any sub-components of one or more processing systems, including software, firmware, hardware or any combination or subset thereof, which embody the invention. User input may be received from the keyboard, mouse, pen, voice, touch screen, or any other means by which a human can input data into a computer, including through other programs such as application programs.

It should be understood that the examples and embodiments described herein are for illustrative purposes only and that various modifications or changes in light thereof will be suggested to persons skilled in the art and are to be included within the spirit and purview of this application and claims.

What is claimed is:

1. A method for providing multimedia entertainment, comprising:
providing a source of stored multimedia segments;
receiving user supplied real-time multimedia signals;
interleaving said stored multimedia segments with said real-time multimedia signals to produce a combined multimedia output;
displaying said combined multimedia output.

2. The method of claim 1 wherein said multimedia comprises images and sound.

3. The method of claim 1, wherein displaying of said combined multimedia output is immediate or delayed.

4. The method of claim 3 further comprising transmitting said combined multimedia output to a remote location over a communications network.

5. The method of claim 4 wherein said communication network comprises broadband, baseband, or radio broadcast transmission.

6. The method of claim 1 further comprising storing said combined multimedia output.

7. The method of claim 1 further comprising storing said user supplied real-time multimedia signals as user supplied segments.

8. The method of claim 1, further comprising charging said user a fee.

9. The method of claim 1 wherein said source of stored multimedia segments comprises a Digital Video Recorder.

10. The method of claim 1 wherein said stored multimedia segments are selected randomly from a plurality of pre-recorded segments.

11. The method of claim 1 wherein said stored multimedia segments are selected from a plurality of pre-recorded segments in accordance with predetermined criteria.

12. The method of claim 11 wherein said predetermined criteria are selected in accordance with a criteria input.

13. The method of claim 1 wherein said stored multimedia segments comprise at least one pre-recorded segment of an entertainment host interleaved at the beginning of said user supplied real-time multimedia signals.

14. The method of claim 13 wherein said pre-recorded segment of an entertainment host interleaved at the beginning of said user supplied real-time multimedia signals comprises an introduction.

15. The method of claim 1 wherein said stored multimedia segments comprise at least one pre-recorded segment of an entertainment host interleaved at the end of said user supplied real-time multimedia signal.

16. The method of claim 15 wherein said pre-recorded segment of an entertainment host interleaved at the end of said user supplied real-time multimedia signals comprises a postscript.

17. The method of claim 1 wherein said stored multimedia segments comprise at least one pre-recorded segment in the form of an advertisement interleaved with said user supplied real-time multimedia signals.

18. The method of claim 1 wherein said stored multimedia segments comprise at least one pre-recorded segment in the form of user instructions interleaved with said user supplied real-time multimedia signals.

19. The method of claim 1 wherein said user supplied real-time multimedia signals are derived from a audio-visual karaoke system.

20. The method of claim 19 wherein the audio-visual karaoke system comprises:
a source of selectable musical compositions that include both music and lyrics;
a first video display screen for displaying said lyrics to the user;
an input device for receiving said user supplied real-time multimedia signals; wherein said multimedia signals comprise audio input from the user and video input from the user;
an audio mixing device for mixing said audio input from the user with said music to provide a combined audio output; and
a multimedia integration device for interleaving video input from the user, said combined audio output, and said stored multimedia segments.

21. The method of claim 20 further comprising a second video display screen for displaying a video portion of said combined multimedia output.

22. The method of claim 1 further comprising capturing at least a portion of said combined multimedia output and supplying said portion to the user.

23. The method of claim 1 further comprising capturing an archive of said combined multimedia output.

24. A system for providing multimedia entertainment, comprising:
a source of stored multimedia segments;
apparatus for receiving user supplied real-time multimedia signals;
an integration device for interleaving said stored multimedia segments with said real-time multimedia signals to produce a combined multimedia output;
an output device for outputting said combined multimedia output.

25. The system of claim 24 wherein said multimedia comprises images and sound.

26. The system of claim 24, wherein said output device provides for immediate or delayed output of said combined multimedia output.

27. The system of claim 26 further comprising a transmitter for transmitting said combined multimedia output to a remote location over a communications network.

28. The system of claim 27 wherein said transmitter comprises broadband, baseband, or radio broadcast transmission.

29. The system of claim 24 further comprising a storage device for storing said combined multimedia output.

30. The system of claim 29 further comprising storing said user supplied real-time multimedia signals as user supplied segments.

31. The system of claim 24, further comprising a payment receiving device.

32. The system of claim 24 wherein said source of stored multimedia segments comprises a Digital Video Recorder.

33. The system of claim 24 wherein said stored multimedia segments are selected randomly from a plurality of pre-recorded segments.

34. The system of claim 24 wherein said stored multimedia segments are selected from a plurality of pre-recorded segments in accordance with predetermined criteria.

35. The system of claim 34 wherein said predetermined criteria are selected in accordance with a criteria input.

36. The system of claim 24 wherein said stored multimedia segments comprise at least one pre-recorded segment of an entertainment host interleaved at the beginning of said user supplied real-time multimedia signals.

37. The system of claim 36 wherein said pre-recorded segment of an entertainment host interleaved at the beginning of said user supplied real-time multimedia signals comprises an introduction.

38. The system of claim 24 wherein said stored multimedia segments comprise at least one pre-recorded segment of an entertainment host interleaved at the end of said user supplied real-time multimedia signal.

39. The system of claim 38 wherein said pre-recorded segment of an entertainment host interleaved at the end of said user supplied real-time multimedia signals comprises a postscript.

40. The system of claim 24 wherein said stored multimedia segments comprise at least one pre-recorded segment in the form of an advertisement interleaved with said user supplied real-time multimedia signals.

41. The system of claim 24 wherein said stored multimedia segments comprise at least one pre-recorded segment in the form of user instructions interleaved with said user supplied real-time multimedia signals.

42. The system of claim 24 wherein said user supplied real-time multimedia signals are derived from a audio-visual karaoke system.

43. The system of claim 42 wherein the audio-visual karaoke system comprises:
a source of selectable musical compositions that include both music and lyrics;
a first video display screen for displaying said lyrics to the user;
an input device for receiving said user supplied real-time multimedia signals; wherein said multimedia signals comprise audio input from the user and video input from the user;
an audio mixing device for mixing said audio input from the user with said music to provide a combined audio output; and
a multimedia integration device for interleaving video input from the user, said combined audio output, and said stored multimedia segments.

44. The system of claim 43 further comprising a second video display screen for displaying a video portion of said combined multimedia output.

45. The system of claim 43 further comprising a recorder for capturing at least a portion of said combined multimedia output and supplying said portion to the user.

46. The system of claim 43 further comprising a recorder for capturing an archive of said combined multimedia output.

47. The system of claim 24 wherein said apparatus for receiving user supplied real-time multimedia signals comprises at least one camera.

48. The system of claim 24 wherein the combined multimedia output comprises as a combination of interleaved segments:
(a) stored multimedia segments comprising at least one of host multimedia segments, advertising multimedia segments, and information multimedia segments;
(b) real-time multimedia signals comprising user audio input signals mixed with music and video input signals; and
(C) stored portions of said real-time multimedia signals.

49. The system of claim 48 wherein the stored portions of said real-time multimedia signals are enhanced with special effects.

50. A multimedia storage medium produced by the method of claim 1 having said combined multimedia output stored thereon.

51. The multimedia storage medium of claim 50 wherein said combined multimedia output comprises:
(a) stored multimedia segments comprising at least one of host multimedia segments, advertising multimedia segments, and information multimedia segments;
(b) real-time multimedia signals comprising user audio input signals mixed with music and video input signals; and
(c) stored portions of said real-time multimedia signals.

52. A real-time broadcast produced by the method of claim 1 comprising broadcast of said combined multimedia output.

53. The real-time broadcast of claim 52 wherein said combined multimedia output comprises:
(a) stored multimedia segments comprising at least one of host multimedia segments, advertising multimedia segments, and information multimedia segments;
(b) real-time multimedia signals comprising user audio input signals mixed with music and video input signals; and
(c) stored portions of said real-time multimedia signals.
